(19) United States
(12) Patent Application Publication
(10) Pub. No.: US 2003/0031882 A1
(43) Pub. Date: Feb. 13, 2003

(54) Genuine gold coating process and product

(76) Inventor: Charles E. Quick, Middletown, NY (US)

Correspondence Address: ALFRED M. WALKER, 225 OLD COUNTRY ROAD, MELVILLE, NY, 11747-2712, US

(21) Appl. No.: 10/211,819

(22) Filed: Aug. 3, 2002

Related U.S. Application Data
(60) Provisional application No. 60/311,493, filed on Aug. 10, 2001.

(51) Int. Cl. B32B 15/08; B05D 1/12

(52) U.S. Cl. 428/457; 428/458; 428/938; 428/180

(57) ABSTRACT

Non-flat surfaces, such as domes with complex curves, are coated with particle specks of genuine gold deposited onto a film substrate layer. The particles are made from vapor deposited or sputter deposited genuine gold upon film laminates, which are preferably segmented and cut to form the genuine gold particle specks. These genuine gold particle specks are mixed in a resin binder and sprayed upon the non-flat surfaces, forming a visually seamless cover upon the non-flat surface.

### BACKGROUND OF THE INVENTION

It is well known that metallized coating compositions can add glitter and sparkle to manufactured objects such as automobiles.

For example, McAdow (U.S. Pat. No. 3,988,494) describes the use of a transparent film laminate using a central layer of vacuum deposited aluminum; this film is cut into flakes of extremely small dimensions, and the flakes are added to a coating composition (ie.—paint).

Minghetti (U.S. Pat. No. 6,077,575) discusses the use of metallized plastic film (PET) which is then cut into particles and added to liquid monomers. These then form suspended accent particles in a finished acrylic product through the use of preformed acrylic particles in the matrix as a method of achieving more even distribution.

Quick (U.S. Pat. No. 5,714,367) describes the formation of a metallized plastic film using a vacuum deposited layer of genuine gold from 100 to 1200 Angstroms thick. This film is then used as part of a thicker laminate structure to create a three dimensional sign making blank.

Except for the ancient art of gilding with gold leaf, the prior art does not reveal a process for coating objects of arbitrary shape, such as with complex curves, including spheres, domes, etc., and a wide range of sizes with genuine gold.

### OBJECTS OF THE INVENTION

It is therefore an object of this invention to provide a process for coating objects of arbitrary shape and size with genuine gold without the need for great skill or much labor.

Other objects will become apparent from the following description of the present invention.

### SUMMARY OF THE INVENTION

In keeping with these objects and others which may become apparent, the present invention applies genuine gold to a film substrate, which is then cut into micro-chips or specks and then spray applied to three dimensional or flat surfaces, creating a surface of unparalleled brilliance not achievable by other means.

“Genuine gold”, as used in the present invention, is at least 12 carat, that is, it is made up of at least 12 out of 24 parts gold (i.e. 50 percent). In this invention, genuine gold of from 22-24 carat is used. 22 carat gold is an alloy that is 22 parts gold and 2 parts silver, nickel, copper, etc.; 24 carat is 100% gold. Gold is inert, which is why it is fade resistant and will not tarnish.

In contrast, some metals such as aluminum with a yellow pigment (to simulate gold) will actually dissolve and lose their metallic appearance when exposed to water that is basic (i.e. pH>7).

The process of the present invention starts with a selection of the desired film material. For example, the film material may be polyester PET film, TEDLAN polyvinyl fluoride film, high heat resistant CALADEX film, polymids or polycarbonates, such as LEXAN. A range of gold flakes of from 300 to 1200 Angstroms, preferably from 300 to 600 Angstroms, is vapor deposited on the film substrate. The gold can be deposited on the film substrate by vacuum coating, wherein in a vacuum the fold is heated and boiled. Additionally, the gold can be deposited by sputter deposition, where a block of gold is impacted by the force of molecules striking the block of gold, causing the gold to be deposited upon a substrate.

Although a sheet of this film itself can be used to decorate three dimensional objects by being wrapped around or otherwise attached to the objects, such as picture frames or cylinders, for certain objects, such as domes with non-flat and complex curve geometries and sizes, this is impossible to achieve without wrinkling of the film.

For example, this direct film technique is only practical on very large domes with a large arc radius (approaching a planar surface).

The next step of the process involves cutting the gold metallized film into small specks of a uniform size and shape. Speck particles can be a variety of shapes, but hexagonal and square shapes are popular since they eliminate waste (by being configured as a perfect “tiling”). Although triangles can be used, with their sharp points they tend to clog spray nozzles. Therefore, square and hexagonal shapes are preferable since they avoid sharp points.

These specks of gold metallized film are preferably from 0.002 inch to 0.25 inch in size (measured from side to side of a square, or from parallel side to parallel side of a hexagon). Finally, these specks are added to a transparent liquid binder and sprayed onto the object to be coated. Typically useful binders include fiberglass resins, acrylics, or other water based or solvent based binders.

The resultant product is a metallized plastic film for transferring decorative genuine gold to a surface to be coated. While the film can be attached to in sheets to flat or cylindrical surfaces, the film has to be cut and segmented into sprayable particles for adherence to non-flat surfaces with complex curves, such as domes. For domes, the film includes at least two segmentable layers, including a transparent film substrate layer and a further layer of vapor-deposited gold adhered to the segmentable transparent film layer. Preferably, the vapor-deposited gold layer has a thickness of from about 300 angstrom units to about 1200 angstrom units. The substrate film thickness is from about 0.5 mil to about 10 mils and the purity of the vapor-deposited genuine gold is from about 12 karats to about 24 karats.

The resultant product provides a coating material for transferring the decorative genuine gold to the non-flat surface to be coated. This coating material is made from the segmentable substrate layers which are cut and segmented into finely divided polygonally-shaped particles, such as squares or hexagons, of the gold-metallized transparent film layer, which are mixed with and dispersed in a suitable transparent liquid binder. This gold-metallized transparent film includes the transparent film substrate layer and the top layer of vapor-deposited gold adhered to the transparent film layer.

The liquid binder is capable of drying after application with a transparent protective residue. When the gold-metallized film is segmented and cut into particles the size of each of the finely divided particles of gold-metallized transparent film varies from about 0.002 inches to about 0.25 inches, when measured from parallel side to parallel side of the particles, depending on the size of the non-flat surface to be coated. For example, a gold dome of a religious institution having a large diameter of approximately twenty feet and which is elevated from fifty to one hundred feet or more above the ground, can have particles of about 0.25 inches in size.

A method of coating surfaces with decorative gold includes the steps of providing a genuine gold-metallizing transparent substrate film by adhering a layer of genuine gold of purity from about 12 karats to about 24 karats by vapor deposition wherein the thickness of the genuine gold layer is from about 300 angstroms units to about 1200 angstrom units and wherein the thickness of the substrate film is from about from about 0.5 mil to about 10 mils. The method further includes the steps of dividing the genuine gold-metallized film into polygonal-shaped particles sized from about 0.002 inches to about 0.250 measured from parallel side to parallel side of the particles, and mixing the polygonal film particles with a suitable liquid binder. These particles are agitated in the binder mixture to form a uniform dispersion of polygonal film particles within the binder. Then the particle and binder mixture is sprayed through a nozzle on a surface to be coated and the binder is allowed to dry.

In that manner, a non-flat surface with complex curves, such as a building dome, can be covered with a layer of genuine gold flakes in a binder, thereby imparting a brilliance achievable only with genuine gold.

### BRIEF DESCRIPTION OF THE DRAWINGS

The present invention can best be understood in connection with the accompanying drawings. It is noted that the invention is not limited to the precise embodiments shown in drawings, in which:

FIGS. 1A, 1B, 1C and 1D are perspective views of four objects illustrating limitations of direct film coating process;

FIG. 2 is a top plan view of one embodiment for a hexagonal speck of this invention;

FIG. 3 is a crossectional detail view of a speck of gold metallized film of this invention; and,

FIG. 4 is an enlarged surface view of a surface coated with the process of this invention.

### DETAILED DESCRIPTION OF THE INVENTION

The application of genuine gold specks to non-flat complex curve surfaces of the present invention has broad applications to many technical fields for a variety of articles. For illustrative purposes only, a preferred mode for carrying out the invention is described herein.

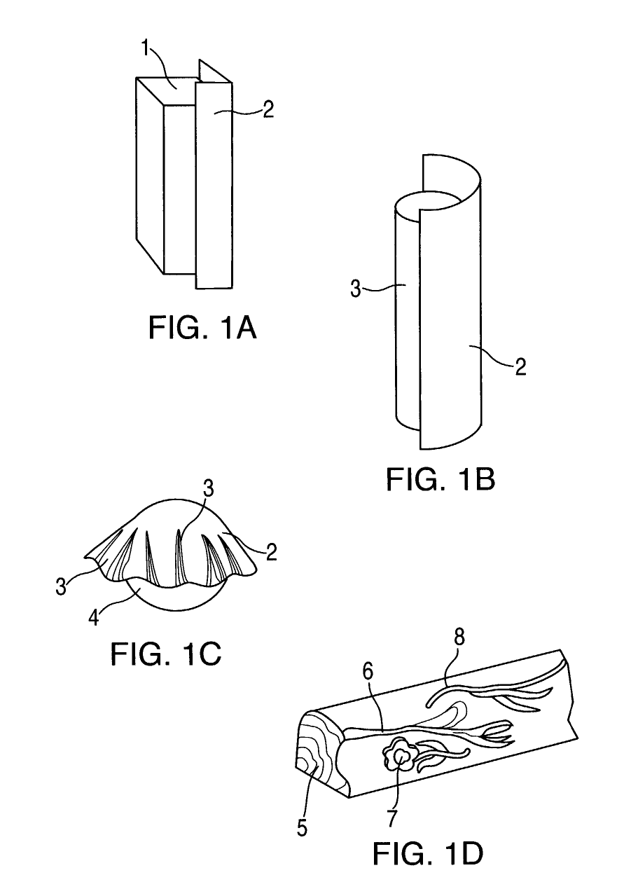

FIGS. 1A, 1B, 1C and 1D show four objects of different geometries. In FIG. 1A, a rectangular crossection rod 1 is shown with a film 2 being used as a coating. Film 2 can be a genuine gold deposited plastic film. Film 2 can be folded to go around these edges without creasing. However, if all four surfaces of rod 1 are in view, the seam may have to be disguised. Also, an adhesive bond between film 2 and rod 1 must be established. Any imperfections in the surface of rod 1 or in the adhesive layer is most likely visible on the exterior surface of film 2.

In FIG. 1B, a circular crossection rod 3 with film 2 is illustrated. Here too, creasing is not a problem, but surface imperfections and seams must still be addressed.

In FIG. 1C, there is shown sheet 2 draped over a sphere 4 showing extensive creasing 3 of sheet 2. Thus convex surfaces or compound curved surfaces are not good candidates for film coverage.

FIG. 1D shows a small section of elaborately decorated picture frame 5 with embossed features 6 incorporating both compound curves 8 as well as concave features 7. No attempt has been made to show the extensive creasing that would be encountered in any attempt to neatly cover this surface with a film.

In all examples, the coating process of this invention encounters no problem with the geometry, seams, or with surface irregularities.

FIG. 2 shows a single hexagon speck 10 as is cut from film 2 by a device such as a guillotine punch. Dimension A may be 0.002″ (50.8 microns) to 0.25″ (6350 microns). Different sizes should be used for different applications. Below 0.002″, the human eye cannot distinguish individual particles; the surface looks monochromatic and of uniform texture.

As the size of particle speck 10 is increased, individual particles 10 can be distinguished at close distances. Larger particle size presents a smoother surface for light shining off the surface; this appears as greater brilliance relative to smaller particles.

Both the spray tip size as well as the viewing distance are used as a guideline to the speck size selected. Large architectural domes, typically viewed from fifty to one hundred feet or more, should use 0.025″ (635 microns) hexagons.

Spraying of specks 10 upon the complex cure surfaces can be accomplished using compressed air, airless, or electrostatic techniques. Binders can be fiberglass resin, acrylic, water based systems, or solvent based systems.

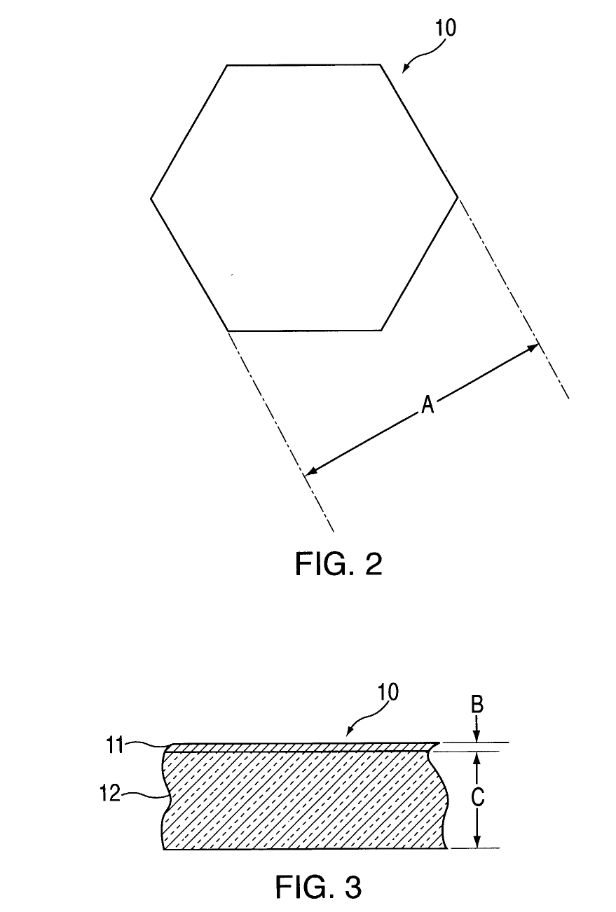

FIG. 3 shows a crossection of speck 10. The top genuine gold layer 11 is of dimension B which ranges therein from 300 to 600 Angstroms. The film of dimension C is preferably any of the following substrates: PET film (polyester), TEDLAR polyvinyl fluoride film, CALADEX film—PET high heat resistant film, Polyimid—high heat resistant polymer, or LEXAN polycarbonate.

Dimension C can vary from 0.5 mil (12.7 microns) to 10 mils (254 microns); 0.25 mils is too thin for web cutting (wrinkling or buckling), while above 10 mils, settling of heavy particles from the binder will occur.

Thin film depositing is used to deposit the genuine gold, such as by vacuum coating or by sputter deposition. In vacuum coating, the genuine gold metal is heated to a boil in a vacuum. In sputter deposition, energetic molecules in a lower vacuum bombard a block of genuine gold and dislodge particles thereof to be deposited on the substrate.

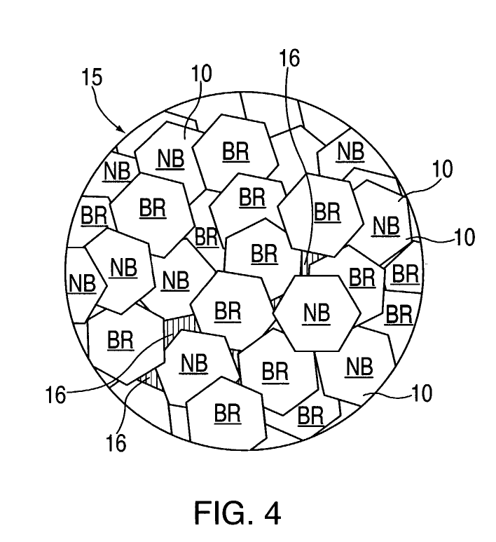

FIG. 4 shows a greatly enlarged detail of a small section 15 of a surface coated using this invention. Hexagon flakes 10 are shown in a random overlapped arrangement almost totally covering the area. Three small areas of non coverage 16 are also shown, but these are not be distinguished at normal viewing distance.

Some of the specks 10 in FIG. 4 are labeled BR (bright) while others are labeled NB (not bright). At this close-up distance, the individual tilt of each speck 10 determines if they reflect ambient light into the viewer's eye (BR) or not (NB).

At a normal viewing distance, a high brightness with highlights determined by shape (as in a gold leaf covered similar item) is observed.

As a result, genuine gold is applied to a film substrate and then cut into micro-chips or specks and then spray applied to three dimensional or flat surfaces, which creates a surface of unparalleled brilliance not achievable by other means.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing from the scope of the invention as noted in the appended claims.

I claim:

1. A metallized plastic film for transferring decorative genuine gold to a non-flat surface having at least one complex curve to be coated, comprising:
a transparent film substrate layer;
a layer of vapor-deposited gold adhered to said transparent film layer; and,
said metallized, plastic film being segmented and cut into a plurality of particles adherable to said non-flat surface having said at least one complex curve.

2. The metallized film of claim 1 wherein said vapor-deposited genuine gold layer has a thickness of from about 300 angstrom units to about 1200 angstrom units; and wherein said substrate film thickness is from about 0.5 mil to about 10 mils; and
the purity of said vapor-deposited genuine gold is from about 12 karats to about 24 karats.

3. The metallized film of claim 1 wherein said vapor-deposited genuine gold layer has a thickness of from about 300 angstrom units to about 600 angstrom units; and wherein said substrate film thickness is from about 0.5 mil to about 10 mils; and
the purity of said vapor-deposited genuine gold is from about 22 karats to about 24 karats.

4. A coating material for transferring decorative genuine gold to a non-flat surface having at least one complex curve to be coated, said coating material comprising:
a plurality of finely divided polygonally-shaped particles of a genuine gold-metallized transparent film mixed with and dispersed in a suitable transparent liquid binder; said genuine gold-metallized transparent film comprising a transparent film substrate layer and a layer of vapor-deposited gold adhered to said transparent film layer;
said liquid binder being capable of drying after application with a transparent protective residue; and wherein
said vapor-deposited genuine gold layer has a thickness of from about 300 angstrom units to about 1200 angstrom units; and wherein
said substrate film thickness is from about 0.5 mil to about 10 mils; and wherein
the purity of said vapor-deposited genuine gold is from about 12 karats to about 24 karats; and wherein
the size of said finely divided particles of genuine gold-metallized transparent film are from about 0.002 inches to about 0.25 inches measured from parallel side to parallel side of said particles.

5. The coating material of claim 3 wherein said finely divided particles of genuine gold-metallized transparent have a hexagonal shape.

6. The coating material of claim 3 wherein said finely divided particles of genuine gold-metallized transparent have a square shape.

7. A coating material for transferring decorative genuine gold to a surface to be coated, said coating material comprising:
a plurality of finely divided polygonally-shaped particles of a gold-metallized transparent film mixed with and dispersed in a suitable transparent liquid binder; said gold-metallized transparent film comprising a transparent film substrate layer and a layer of vapor-deposited genuine gold adhered to said transparent film layer;
said liquid binder being capable of drying after application with a transparent protective residue, wherein:

8. The coating material as in claim 7, wherein:
said vapor-deposited gold layer has a thickness of from about 300 angstrom units to about 600 angstrom units; and wherein
said substrate film thickness is from about 0.5 mil to about 10 mils; and wherein
the purity of said vapor-deposited gold is from about 22 karats to about 24 karats; and wherein
the size of said finely divided particles of gold-metallized transparent film are from about 0.002 inches to about 0.25 inches measured from parallel side to parallel side of said particles.

9. The coating material of claim 8 wherein said finely divided particles of gold-metallized transparent have a hexagonal shape.

10. The coating material of claim 8 wherein said finely divided particles of gold-metallized transparent have a square shape.

11. A method of coating surfaces with decorative gold, comprising the steps of:
a. gold-metallizing a transparent substrate film by adhering a layer of gold of purity from about 12 karats to about 24 karats by vapor deposition wherein the thickness of said gold layer is from about 300 angstroms units to about 1200 angstrom units and wherein the thickness of said substrate film is from about from about 0.5 mil to about 10 mils;
b. dividing said gold-metallized film into polygonal-shaped particles sized from about 0.002 inches to about 0.250 measured from parallel side to parallel side of said particles;
c. mixing said polygonal film particles with a suitable liquid binder;
d. agitating said particle—binder mixture to form a uniform dispersion of said polygonal film particles within said binder;
e. spraying said particle—binder mixture on a surface to be coated; and
f. allowing said binder to dry.

12. The method of claim 11 wherein said polygonal-shaped particles of genuine gold-metallized film are hexagons.

13. The method of claim 11 wherein said polygonal-shaped particles of genuine gold-metallized film are squares.

14. The method of coating surfaces with decorative genuine gold, wherein the thickness of said genuine gold layer is from about 300 angstroms units to about 600 angstrom units.

15. The method of claim 13 wherein said polygonal-shaped particles of gold-metallized film are divided into hexagons.

16. The method of claim 13 wherein said polygonal-shaped particles of gold-metallized film are divided squares.
